(19) United States
(12) Patent Application Publication
(10) Pub. No.: US 2013/0036442 A1
(43) Pub. Date: Feb. 7, 2013

(54) SYSTEM AND METHOD FOR VISUAL SELECTION OF ELEMENTS IN VIDEO CONTENT

(71) Applicant: Christopher R. Wingert, San Diego, CA (US)

(72) Inventor: Christopher R. Wingert, San Diego, CA (US)

(73) Assignee: QUALCOMM Incorporated, San Diego, CA (US)

(21) Appl. No.: 13/252,855

(22) Filed: Oct. 4, 2011

Related U.S. Application Data
(60) Provisional application No. 61/515,731, filed on Aug. 5, 2011.

(51) Int. Cl. H04N 21/47

(52) U.S. Cl. 725/60

(57) ABSTRACT

A method and system for generating an image that displays a portion of a scene from a video that is being displayed on a first device, the image having at least one selectable item. When an item is selected, a menu may be displayed to allow a user to receive more information about the item. The method may include displaying the selectable image on a second device.

### CLAIM OF PRIORITY UNDER 35 U.S.C. §119

The present Application for Patent claims priority to Provisional Application No. 61/515,731 entitled “System and Method for Visual Selection of Elements in Video Content” filed Aug. 5, 2011, and assigned to the assignee hereof and hereby expressly incorporated by reference herein.

### BACKGROUND

1. Field

The features described below relate generally to viewing video content. More specifically, various embodiments are directed to an apparatus and method for visually selecting and accessing information regarding items within the video content.

2. Background

Video content may be divided into scenes. As the video content is displayed, the display shows the scenes sequentially. The viewer of the video content may desire to ascertain more information regarding an item that is displayed in the video. Embodiments of the system and method for visual selection of elements in a video content are directed to improving the process of ascertaining more information regarding items in the video.

### SUMMARY

A method and system for generating an image that displays a portion of a scene from a video that is being displayed on a first device, the image having at least one selectable item. Upon the selection of an item (physical object or person), a menu may be displayed to allow a user to receive more information about the item. The method may include displaying the visually selectable image on a second device.

An apparatus for visually selecting items in video content includes a computer device configured to determine the segment of the video being displayed on a first user device. The apparatus includes a different computer that is configured to send data to a second user device, the data including an image that includes at least a portion of the video being displayed. The image having at least one selectable item such that when a user selects the at least one item, a menu is generated with options that provide the user information regarding the at least one item. When an item is selected, a menu may be displayed to allow a user to receive more information about the item. The method may include displaying the selectable image on a second device.

A method stored on a non-transitory machine-readable media for visually selecting items in a video, the machine-readable medium including program code stored therein executable by one or more processors includes providing an image generation system that provides an image from a portion of a scene in a video that is being displayed on a first device, the image having at least one visually selectable item.

### BRIEF DESCRIPTION OF THE DRAWINGS

FIG. 1 is a schematic diagram of a computer-implemented data processing system according to an example embodiment.

FIG. 2 is a method that may be implemented by systems shown in FIG. 1.

FIG. 3 is a method that may be implemented by the second display device and the Image generation system from FIG. 1.

FIG. 4 is a method that may be implemented by the image generation system from FIG. 1.

FIG. 5 is a method that may be implemented by the second display device from FIG. 1.

FIG. 6 is a screen shot of a screen that may be provided to a user on a second display device when the user has requested more information regarding a scene.

### DETAILED DESCRIPTION

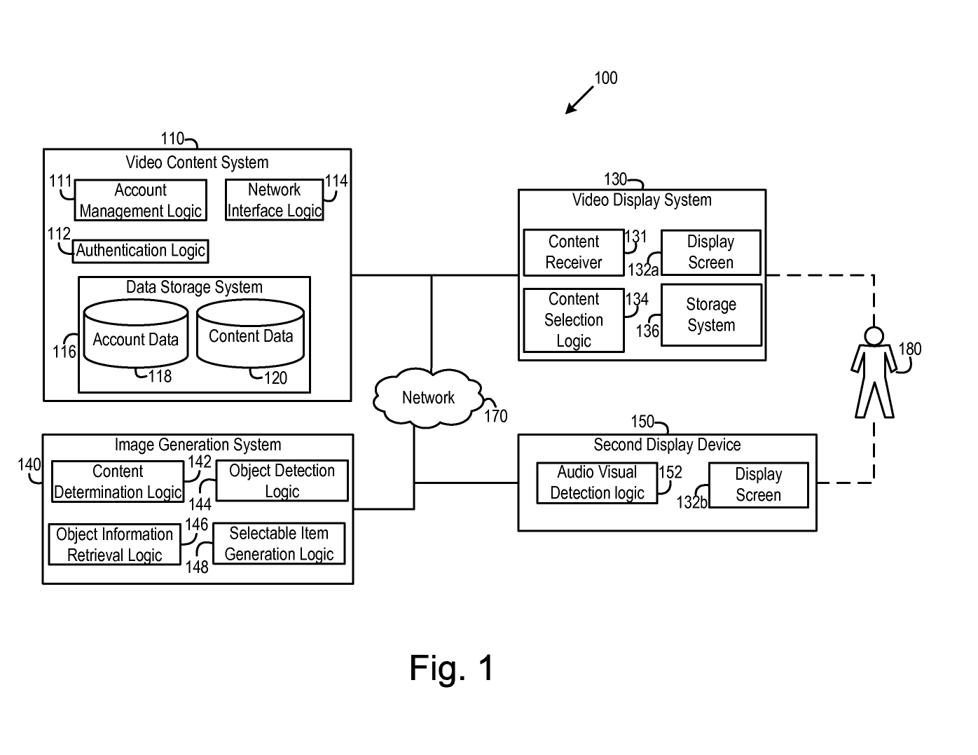

FIG. 1 shows a computer-implemented data processing system 100 that is used by a content provider to provide video content (i.e. video images that are sequentially displayed and audio sound that is synchronized with the video images) and other content to user 180. The user 180 may be a viewer of the video content and/or individual consumers that have accounts with the video content provider or are otherwise able to obtain content from the video content provider. The video content provider may provide video content to a view for a fee that is charged to the user or an account holder. In an example embodiment, the fee maybe charged periodically, at any suitable time, such as, but not limited to, daily, monthly, or yearly.

The features described below relate generally to displaying video content on a video display system having a first display screen and simultaneously displaying additional information (in sync with the content) on a second display screen e.g. associated with a second display device. The second display screen shows images of visually selectable physical objects or people within an image from the video content. The second display device receives representative images that are also displayed in the video content. The content producer may mark up the representative image with menus that provide more information regarding, for example: a person in the scene. The menu items may include for example, other films the person may have acted in, the clothing the person may be wearing or a link to the seller of the clothing. As the video progresses a new image may be shown, the new image represents a new scene of the video content. Accordingly, the image may be time synchronized with the video content being viewed.

In an example embodiment, a user may view the video content on a television and the second display device may be a computer, such as but not limited to a desktop, laptop, tablet, cell phone or other suitable mobile devices. In one example embodiment, the second display device communicates with a server that stores images and metadata regarding a one or more video content. The server may provide computer images and metadata related to the video content that is currently being viewed by the user. The second display device may display video content synchronized images with an annotated menu. The annotated menu may allow the user to select a person visually and select from a menu that shows additional choices regarding the selected person.

The synchronization between the video content playback and the image displayed on the second display device may be achieved in a variety of ways. For example, the user may input synchronization data into the second display device which may be communicated to a server. In an example embodiment, the user 180 chooses a scene visually from a plurality of thumbnails corresponding to various scenes in the video content. The synchronization data may inform the server regarding the current time location of the video content playback. In another example embodiment, the device being used to display the video may communicate with the server using metadata to keep the image synchronized with the video content playback. In another example, the second display device may have a microphone that makes a sound recording of the video content being displayed. The sound recording may be sent to the server. The server may be configured to determine the scene that is currently being played based on the sound recording. Upon determining the scene that is currently being played, the second display device displays an image associated with the scene that includes a selectable menu. The above systems and methods are described in greater detail below.

The data processing system 100 includes various systems, for example, video content system 110, video display system 130, image generation system 140, second display device 150 (which may be a portable device) and network 170. Systems 110 and 140 each comprise a computer system (e.g., one or more servers each with one or more processors) configured to execute instructions stored in non-transitory memory to implement the operations described herein associated with logics shown in FIG. 1. Although, in the illustrated embodiments, systems 110 and 140 are shown as being separate and as communicating through the network 170, it will be appreciated that the systems 110 and 140 may also be integrated in a single processing system.

The video content system 110 may be used by an individual user (e.g., a business owner or employee, a consumer, and so on) to provide audio/video content, such as, but not limited to, movies, sitcoms, news, entertainment or other suitable content. The video content system 110 includes account management logic 111, authentication logic 112, network interface logic 114 and data storage system 116. The account management logic 111 may be implemented on a separate computer system or as part of the video content system 110, as shown in FIG. 1. The account management logic 111 controls the system to access a user profile and determines a level of access for a user 180 attempting to access the video content. For example, the account management logic 111 may control the system to access the account data 118 and determine that only certain users have access to premium content, such as, but not limited to premium channels, pay per view video content or other types of video content.

In an example embodiment, the authentication logic 112 controls the system to receive and verify authentication credentials from the content receiver 131. An example verification process may include the authentication logic 112 verifying a unique identifier of a content receiver 131 against the information in the account data 118. If the identifiers match, then the authentication logic 112 allows the user 180 to access the content data 120. The account management logic 111 may also verify the access level of the account that is assigned to the content receiver 131.

Network interface logic 114 is used by the video content system 110 to communicate with other systems such as the video display system 130. An embodiment of the network interface logic 114 is configured to communicate with the video display system 130 over a proprietary network. The proprietary network may be, for example, but not limited to, cable network, a satellite network, a wireless network or other types of networks. Another embodiment of the network interface logic 114 may be configured to communicate with the video display system 130 over a public network, such as, the Internet. In other embodiments, the network interface logic 114 controls the system to connect to the Internet and permit the user to access the content data 120, for example, through an on-line content area of a website provided by the content provider. Network interface logic 114 may also comprise other logics that is configured to provide an interface for other types of devices such mobile devices including, but not limited to cell phones, tablet computer, smart phones, fax machines, server-based computing systems and so on. In another example embodiment, the network interface logic 114 may be configured to communicate with the image generation system 140 and provide scene information and other information regarding the video that is currently being viewed by the user 180.

The video content system 110 includes connections to one or more data storage systems 116. In an example embodiment, the data storage system 116 includes account data 118 and content data 120. The data storage system 116 may include and/or access various other databases to form a relational database. The account data 118 includes information regarding the user's accounts, preferences and access level. The content data 120 includes video content and information regarding the video content in a file system. The file system may be distributed over a plurality of file locations or systems. The video content may include various types of media and metadata regarding the media. Types of media may include, but is not limited to, compressed or uncompressed, encrypted or unencrypted, audio and/or video media or other suitable media.

Video display system 130 includes one or more systems, for example, content receiver 131, display screen 132a, content selection logic 134 and storage system 136. The various systems of the video display system 130 may include a digital video recorder that stores video content as programmed by the video content provider and the user 180. The content receiver 131 may be configured to receive video content from the video content system 110. After receiving the video content, the content receiver 131 may either store the video to be viewed for a later time, or display the video on the display screen 132a. The user 180 may select from among a plurality of content items using selection logic 134. In various embodiments, the video display system 130 may be configured to receive video and/or audio content from the video content system 110 and/or from one or more other sources such as, other network devices or other video content providers accessible on a network (such as a wide area network but not limited to the Internet or a wireless or wired network system).

The user 180 may access more information regarding the video content by using a second display device 150 to access the image generation system 140 via a network 170. In other embodiments the image generation system 140 may be accessible through the video display system 130 via the network 170. In yet another embodiment, the image generation system 140 may be part of the video content system 110 and may provide information to the video display system 130.

The second display device 150 may include display screen 132b and audio visual detection logic 152. The second display device 150 is any suitable portable device capable of processing video information and communications as described herein, including, but not limited to, a mobile phone, smart phone, tablet computer, laptop computer, or desktop computer. The second display device 150 may have wired or wireless access to a communications network such as but not limited to the Internet. The second display device 150 may access a website provided by the content provider or another entity such as, but not limited to, a local cable provider who has pre-programmed data to appear on the second display device 150. In one embodiment, the second display device 150 may include a user input device that is configured to receive information from the user 180 regarding the video content that is currently being viewed on the video display system 130. Examples of suitable input devices include, but are not limited to, a keyboard, mouse, microphone, video camera or other suitable input device. In an example embodiment, the user 180 may be shown one or more thumbnail images that correspond to one or more scenes in the video content. The user may use an input device to visually select one or more scenes to identify the location of the current video content playback. After receiving the user input, the user input device may generate electronic signals that represent the time location of a video content that is currently being watched. The electronic signals are transmitted to the image generation system 140 in order to retrieve an image that is time synchronized with the video content playback.

The audio visual detection logic 152 may be configured to record a portion of the video currently being played (i.e. portion of the audio signal and/or a portion of the video signal in the video content). The audio visual detection logic 152 may include a microphone and video camera to record the portion of the video. Upon recording the portion of the video content, the second display device 150 may transmit the recorded portion of the video content to the image generation system 140.

In an alternative embodiment, the video content signal being sent to the video display system 130 may be detected by the image generation system 140 or sent to the image generation system 140 by the content receiver 131. Using the video content signal the image generation system 140 generates an image that is time synchronized with the video content playback. The image with visually selectable physical objects or people is sent to the second display device 150 to be displayed on the display screen 132b.

The display screen 132b may be configured to display information regarding the video content. The information displayed by the display screen 132b may include an image, such as a still image or frame, from the video content that represents a portion of the video content currently being viewed by the user 180 on the display screen 132a. In other embodiments, the image can also be a small segment of the video content (e.g. a few frames with audio). As the video content is played and progresses, images are updated such that different images are displayed as the video progresses. In various embodiments, the image may be time synchronized with the scene within the video that is being played. For example, if the video is paused, then the image remains the same at least until the video is played again. In another embodiment, if the video is skipped ahead, the image being displayed on the second display device 150 skips ahead to display a new image at a similar speed as the rate at which the video is being skipped. Similarly, if video is skipped backward, the image being displayed on the second display device 150 is moved backward to display a previously viewed image at a similar speed as the rate at which the video is skipped backward.

The image being displayed on the display screen 132b may include menu items that are configured to provide more information regarding the people or physical objects within the image. The menu items may be accessed by a user 180 moving a pointing device (such as, but not limited to a mouse, finger, stylus or other pointing devices) over a portion of the image that includes a person or physical object and selecting the portion of the image by providing input (such as, but not limited to clicking on a mouse button, pressing using a finger or tapping a stylus) to a pointing device. The pointing device may generate a signal to informs the second display device 150 that a person or an object has been selected. The second display device 150 generates a menu based on information received from the image generation logic 140. An example menu item may be a link to information regarding other films or shows that include the selected person. Other example menu items may be links to the person's biographical information or other websites with information regarding the person. In one embodiment, the image may be displayed in a web browser configured to access the Internet or other networks. Accordingly, the link may be a link to a URL (Universal Resource Locator) with an IP address configured to access the world wide web or other suitable resource locator for accessing the image generation system. In other embodiments, a web browser may be initiated upon the user 180 selecting a link from the menu. In an example embodiment, the people or physical objects within the image may be visually selectable such that when a user selects a person or physical object, the user is provided with links that provide more information about the selected person or physical object.

The image generation system 140 may include content determination logic 142, object detection logic 144, object information retrieval logic 146 and selectable item generation logic 148. Each logic may comprise one or more computer systems that include a processor, memory, hard drive, input and output devices. The content determination logic 142 may be configured to receive the portion of the video recorded by the audio visual detection logic 152 and determine which video is currently being played by the video system 130. In an example embodiment, the content determination logic 152 may generate one or more thumbnail images to allow a user to visually select, using a pointing device, which scene is currently played. In one embodiment, the content determination logic 152 may compare the portion of the video content with one or more databases of other video content to identify the video being played by the video display device 150. The comparison of the video content may include comparing images or sounds received from the audio visual detection logic 152 and the database of images or sounds. In yet another embodiment, the identity of the video may be provided to the content determination logic 142 by the second display device 150 or the video display device 130 or the user 180. The content determination logic 142 may also determine which portion of the video is currently being viewed by the user 180.

In one example embodiment, the content determination logic 142 may determine the audio frequencies of the portion of the video content recorded by the second display device 150 and compare those frequencies with the audio frequencies provided by various content providers in the content data 120. As the video progresses, the content determination logic 142 may determine that another portion of the video is being played and update the image on the display screen 132b. In another embodiment, the audio received from the audio visual detection logic 152 may be converted to text and the text may be used to identify the video and a time location within the video being played. In an example embodiment, an audio to text converter, such as, but not limited to, Dragon® created by Nuance Communication, or other audio to text converters may be used to convert the audio to text. The text may be compared to text from a database containing the text or scripts from one or more video content. The comparison may find a match and in finding a match may allow for a percentage error rate (i.e. 10%, 15% or 20%) based on a known error rate of the audio to text converter. In alternative embodiments, the content determination logic 142 may request information from the video display system 130 in order to keep the image on the display screen 132b time synchronized with the video being played on the display screen 132a.

In an example embodiment, the content determination logic 142 may receive a request from the second display device 150 for information regarding the video content being played on the video display system 130. Upon receiving the request, the content determination logic 142 may send a request through the network 170 (wired or wireless) to the video display system 130 for information regarding the video content that is being shown on the display screen 132a. In an example embodiment, the request may include a query for the identity of the video content and the temporal location of the playback. In response to the request, the video display system 130 may provide the content determination logic 142 the identification information of the video content and/or the temporal location of the video content being displayed on the video display system 130. Upon receiving the temporal location and the identity of the video content, the content determination logic 142 retrieves an image that relates to the temporal location of the video content. The image is provided to the object information retrieval logic 146.

In another embodiment, the user 180 may be prompted by the second display device 150 to provide the identity information of the video content and the temporal location of the video content playback. The second display device 150 may display one or more questions requesting the identity information of the video content and the temporal location (i.e. minutes and seconds). The user 180 determines the identity information by requesting the identity information from the video display system 130. The user 180 provides the identity information using an input device that is in communication (electrically or wirelessly) with the second display device 150 and the second display device 150 may transmit the identity information to the image generation system 140 via the network 170. After providing the identity information for the video content, the second displayed device 150 may display one or more thumbnail images that correspond to one or more scenes in the video content. The second display device 150 receives the one or more thumbnails from the image generation system 140.

In another embodiment, the second display device 150 may display questions to the user 180 to determine at what time the user 180 began watching the video content and based on the current time for the user's geographic location, determine the portion of the video that is currently being displayed by the display screen 132a. The second display device 150 may comprise or have access to a geographic location system that is configured to triangulate the geographic location of the second display device 150 using satellites or wireless network based triangulation. The current time of the user's time zone may be determined based on the user's location. By subtracting the current time from the time the user began watching the video the current playback temporal location of the video content can be determined. For example, if the user began watching video content at 1:00:00 PM and the current time is 1:32:05 PM, then the user is in the 32^{nd} minute and 5^{th} second of the video content. Accordingly, the image generation system 140 may retrieve a pre-selected representative image that corresponds to the 32^{nd} minute and 5^{th} second of the video content.

Once the content determination logic 142 identifies the video and determines the portion of the video content currently being played, the content determination logic 142 may select an image from the portion of the video content being displayed. The image may be representative of the portion of the video currently being viewed by the user 180. In one example embodiment, the image is selected by a person who is associated with one of the content providers. The representative image or images are selected prior to the video content being viewed by the user 180. Accordingly, the images are predefined (pre-selected) for each video content and/or for one or more scenes within a video content. The selected image may include one or more people and/or physical objects.

The object detection logic 144 may be configured to identify the people and physical objects within the selected image. The detection of the people or physical objects may include comparing pixels from one part of the image to another part of the image to determine the outer boundaries of an object. If the outer boundaries of the object are shaped like a person, then a facial recognition algorithm may determine the name of the individual.

In another embodiment, a person may identify the physical objects or people within the image manually using an input device. For example, a software program configured receive input from a person that highlights the boundaries of the people or objects within an image. The input from the person may comprise selecting (using a pointing device) a plurality of points or creating a line along the boundaries of the people or objects to create a selection area. The selection area is configured to display a menu with a list of items, when a user 180 selects the selection area. One image may comprise one or more selection areas.

In one embodiment, if the image includes a physical object like a desk or a lamp, a search may be conducted to find similar images to identify the physical object. The search may involve the image generation system 140 submitting an image to a image search engine (such as, but not limited to picsearch®, Google®, Yahoo®, Bing® and other suitable search engines) and using the textual data from the search results from the image search engine to determine the identity of the physical object.

Once an object has been identified the object information retrieval logic 146 may retrieve information regarding the identified object using a search engine. In one embodiment, the object information retrieval logic 146 sends a query to one or more search engines, such as but not limited to, Google®, Yahoo®, or Bing®. The query to the search engine comprises text or image that identifies the physical objects or people. The first few results that are common among the one or more search engines are used as the text and links for the menu item list associated with each physical object or person in the image. In other embodiments, the object information retrieval logic 146 may be configured to receive the information regarding the object in the form of a plurality of links manually provided by an individual. In an example embodiment, the links may point to web pages or other resources that display more information regarding the object on the display screen 132b.

Upon the generation of the links for each physical object or person, the image may be modified to provide a link that generates a menu when a physical object or person is selected using an input device, such as, but not limited to a mouse, finger or other pointing device. The selectable item generation logic 148 may modify the portion of the image with the identified object to allow a pointing device to select the object by simply moving a pointing device over the object and selecting the object or person. The modification of the portion of the image comprising the identified object or person may include creating a button that is shaped like the identified object and button is located to cover the surface area similar to the identified object within the image. The outer boundaries of the button may be visible to the user 180, but the inner surface area of the button displays the object or person as it appears in the image. For example, in one embodiment, when the object or person is selected, the selectable item generation logic 148 displays a list or menu of links that allow the user 180 to select, using an input device, any one of the links provided in the menu that is associated with the object on the display screen 132b. In one embodiment, the generated menu may be overlaid over the image.

The display screen 132b of the second display device 150 is configured to display an image with selectable objects within the image. In an example embodiment, the display screen 132b may be part of the video display system 130. In another embodiment, the display screen 132a and 132b may be provided as a single display screen.

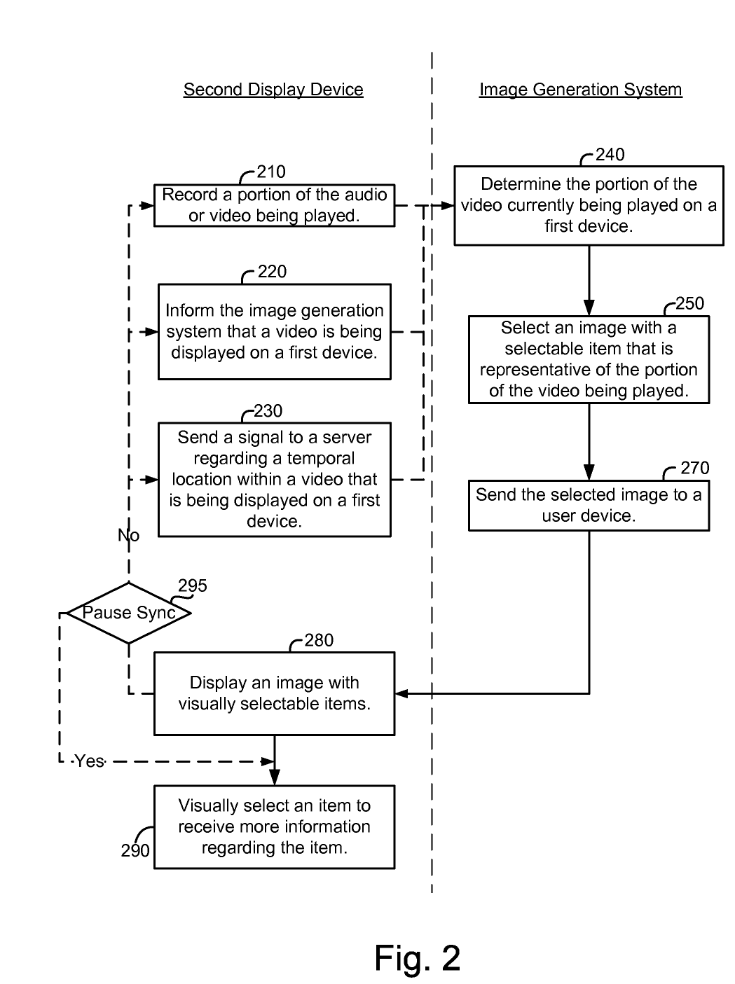

A method that may be implemented by systems shown in FIG. 1 shall be described in FIG. 2. In one embodiment, at step 210, the second display device 150 records a portion of the audio or video being played on a display screen 132a. The display screen 132a may be part of a television that receives it's video content from content providers, such as but not limited to, a cable company, satellite content provider, broadcast, online subscription service or other content providers. In one embodiment, the television includes one or more speakers that generates sounds that are synchronized with the sequentially displayed video frames being displayed on the display screen 132a.

Prior to step 220, the user 180 may inform the second display device 150 regarding when the video content display was initiated using an input device that generates signals to the second display device 150. In one embodiment, at step 220, the second display device 150 informs the image generation system 140 that video content is being displayed on the video display system 130. The second display device 150 may send a signal that informs the image generation system using network 170. Upon receiving said information regarding when the video content display was initiated from the second display device 150. The second display device 150 may inform the image generation system 140 regarding the video playback. The second display device 150 may transmit information through the network 170.

In yet another embodiment, at step 230, the second display device 150 may send a signal to the image generation system 140 identifying a temporal location within a video that is being displayed on the video display system 130. The second display device 150 may determine the temporal location based on input received from the user 180. For example, the second display device 150 may display questions for the user to answer. For example, the second display device 150 may ask, which minute of the content is currently being displayed. If the user 180 is using a cable or satellite service the temporal information is readily available to the user by the user prompting the video display system 130 via a remote control device. In another embodiment, the user 180 may inform the second display device 150 that the requested information is unavailable. In response, the second display device 150 may ask other questions to the user in order to determine the temporal location of the video content, such as but not limited to, how long have you been watching the video content.

Upon receiving the information from the second display device 150, the image generation system 140 identifies the video and determines the portion of the video currently being played on a first device, at step 240. The various methods by which the image generation system 140 may identify the video content are discussed above with respect to FIGS. 1 and 2.

At step 250, the image generation system 140 selects an image with a selectable item that is representative of the portion of the video being played. The various methods by which the selectable item generation logic 148 and the image generation logic 140 may select an image with a selectable person or physical object is discussed above with respect to FIGS. 1 and 2. As discussed above in greater detail, the images may be prior to the video content playback.

Upon selecting an image the image generation system 150 may send the selected image to a second display device 150, at step 270. The image is sent to the second display device 150 using the network 170. At step 280, the second display device 150 may display an image with visually selectable items on display screen 132b. As the video content continues to play or moves to another scene, the displayed image may be updated by iteratively, going through either steps 210, 220 or 230 to steps 240, 250 and 270. The time synchronization of the image being displayed on the second display device 150 and the video content being displayed on the video display system 130 is discussed above with respect to FIGS. 1 and 2. In another embodiment, the user 180 may wish to temporarily pause the time synchronization between the video content playback and the image being displayed on the second display device, at step 295. In one embodiment, the user 180 may indicate, using an input device, the desire to pause the time synchronization. Upon receiving the user input, the video content may continue to move to another scene while the image on the second display device 150 becomes decoupled from being time synchronized with the video content playback. Accordingly, in one embodiment, until the user chooses to synchronize with the video content the image that is shown on the second display device 150 remains the same or does not change. The menu options and/or the links in the menu options remains active while the image on the second display device does not change. The physical objects and people shown in the image may be visually selectable by using an input device such as a mouse, finger or other input devices. At step 290 a user may select using an input device a visually selectable physical object or person to receive more information regarding the physical object or person. By selecting a visually selectable physical object or person, a menu may be displayed on the display screen 132b. The menu may include text and links that may be selected to display more information regarding the person or physical object. The menu items may be links to URLs that may be displayed in a web browser software running on the second display device 150. In another embodiment, once the user 180 has selected an item within the image, the time synchronization with the video content playback may be paused to allow the user to view the requested information regarding the selected item.

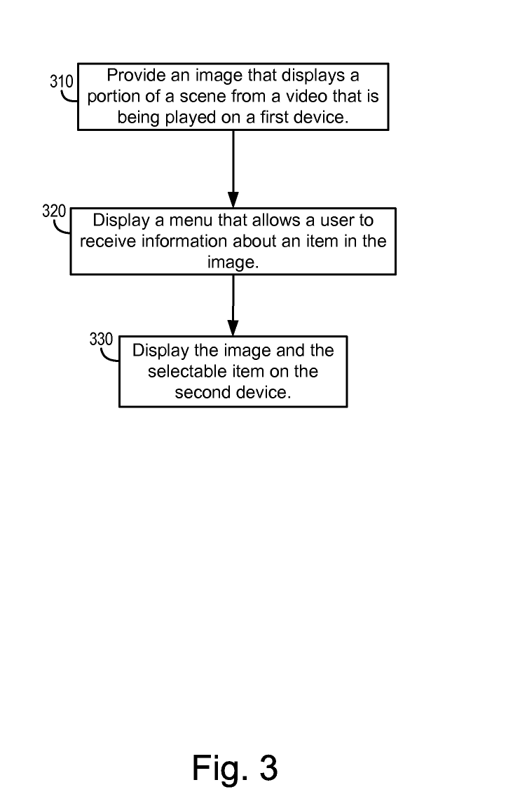

Referring to FIG. 3, FIG. 3 is a method that may be implemented on a second display device 150. At step 310, the second display device 150 may provide an image from a scene in a video that is being played on a video display device 130. The image is provided by the image generation system 140 via a network 170. Upon the user 180 selecting a visually selectable item, at step 320, the second display device 150 displays a menu that provides options that allow a user 180 to select a link to receive information about a person or physical object within the image. At step 330, the second display device 150 may display the image and the selectable item on the display screen 132b.

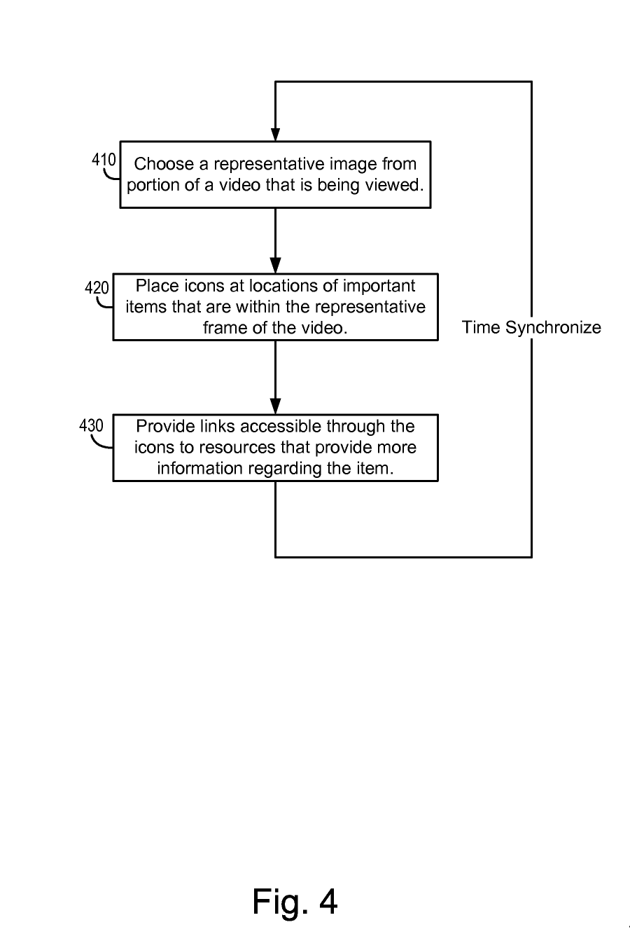

FIG. 4 is a method that may be implemented by the image generation system 140 from FIG. 1. At step 410, the image generation system 140 may choose a representative image for the portion of the video that is being viewed by the user 180. In one embodiment, the representative image may be pre-selected or chosen by a person. In another embodiment, the image generation system 140 may be informed by input provided by an individual regarding the image to use for the portion of the video currently being viewed. At step 420, icons may be placed at locations of items that are within the representative image of the video by input provided by a person. At step 430, the image generation system 140 may provide links accessible through the icons to resources that provide more information regarding the items in the image. The selection of the links may lead to a web browser displaying web pages based on the above description regarding links. Next the image is updated based on the time synchronization with the video content that is being played. For example, another image may be chosen as the representative image for the portion of the video that is being viewed. Time synchronization between the image being display and the video content being viewed may occur by the image displayed by the display screen 132b updating based on the change in the portion of the video being displayed on screen 132b. The methods and systems for time synchronization are discussed in greater detail above with respect to FIGS. 1 and 2.

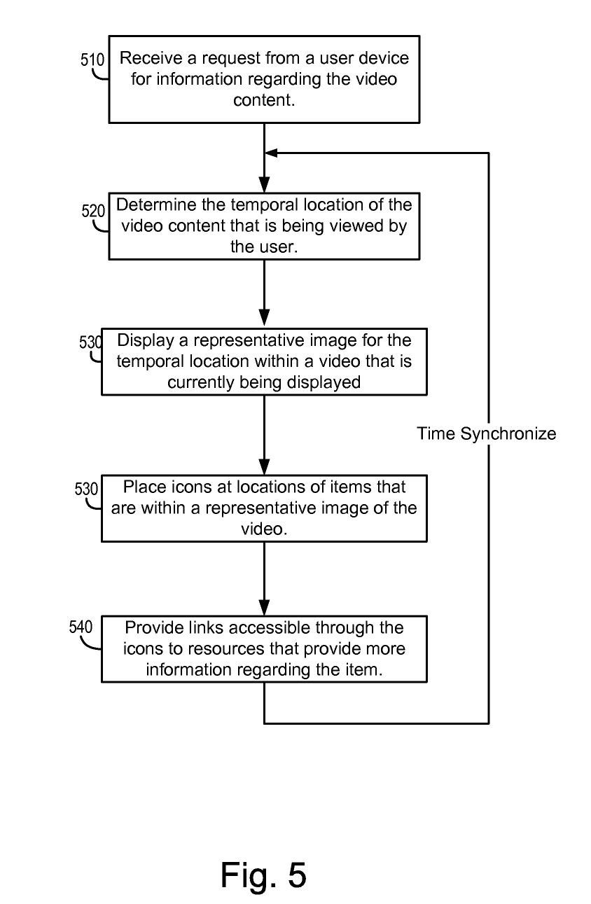

FIG. 5 is a method that may be implemented by the second display device from FIG. 1. At step 510, the second display device 150 may receive a request from the user 180, using an input device (i.e. keyboard or touch screen), for more information regarding the video content being viewed by the user 180. At step 520, the second display device 150 may communicate with the image generation system 140 that determines the temporal location of the video content that is being viewed by the user 180. Based on the temporal location, at step 530, the second display device 150 may display a representative image for the temporal location of the video content that is being played. At step 540, the second display device 150 may place menus at locations of the items that are within the representative image of the video. At step 550, the second display device 150 may provide links accessible through the menu to resources that provide more information regarding the items in the image.

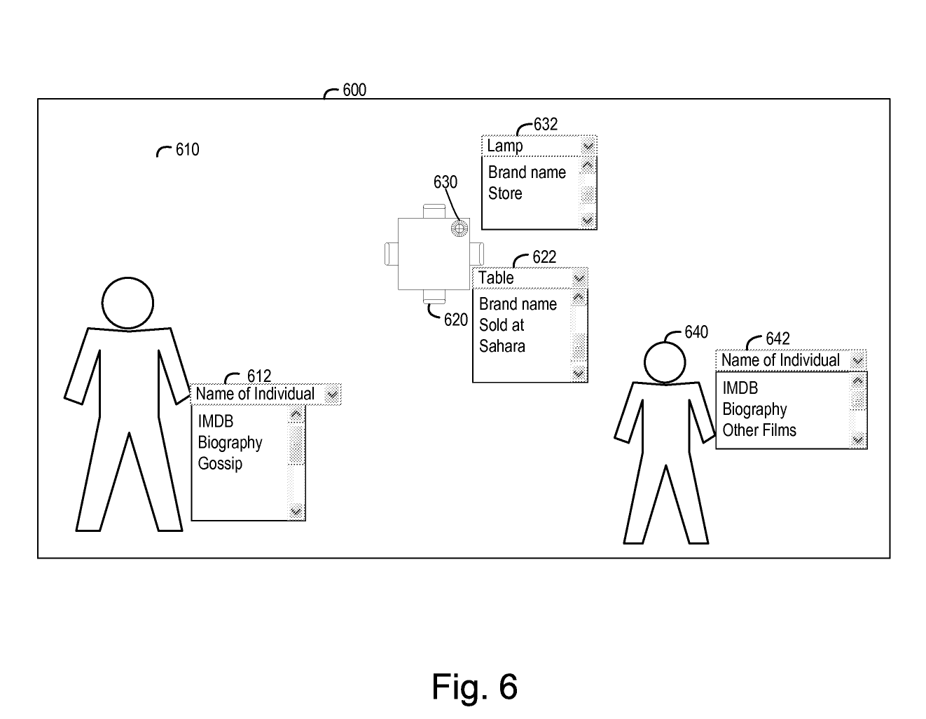

FIG. 6 is a screen shot showing a screen 600 that may be provided to a user 180 when the user 180 requests more information regarding the video content. The screen 600 may be generated by display screen 132b. In another embodiment, a portion of the display screen 132a may display the screen 600. The screen 600 may be updated to different objects or items based on the portion of the video that is being viewed by the user 180 because of the time synchronization. Screen 600 shows two individuals 610, 640, table 620 and lamp 630. With respect to each item shown in screen 600 a menu item may be generated for each item by the image generation system 140, as discussed above. The menu 612 may be displayed when a user 180 visually selects, using an input device, the individual 610. The menu 612 lists the name of the individual and under the name of the individual provides links to IMDB™, biography and gossip websites. Upon the selections of one of the links in the menu, a web page may be opened on the second display device 150 that provides more information about the individual or item. If the object being displayed is a table 620, then the menu 622 may identify the item as a table and the menu 622 may provide links to the manufacturer of table and may provide a link to a retailer, for example, the store that sells the table. Alternatively, the link may be for a different table sold by a different retailer. Also shown on the table is a lamp 630 with a menu 632 that identifies the item as a lamp and provides links that allow the user to buy the lamp at a retailer. The screen 600 shows a second individual 640 with a menu 642. The menu 642 identifies the name of the individual, and provides links to IMDB™, biography and other videos of the second individual 640.

The links shown in screen 600 may be manually provided by a content provider or may be generated automatically by the image generation system 140. The links provided by the menus in screen 600 may be updated by the image generation system 140 when the resources are moved or deleted. In an example embodiment, the image generation system 140 may verify the validity of the link prior to placing the link in the menu.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media, such as non-transitory storage media, that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing devices in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention as defined in the appended claims. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention as expressed in the appended claims.

What is claimed is:

1. A method, comprising:
providing an image that displays a portion of a scene in a video that is being displayed on a first device, the image having at least one selectable item;
in the case where the item is selected, displaying a menu that allows a user to receive more information about the item; and
displaying the image on a second device.

2. The method of claim 1, further comprising synchronizing a change in the image based on the change of the scene in the video being displayed.

3. The method of claim 2, wherein synchronizing includes providing a new image based on the change of the scene in the video being displayed.

4. The method of claim 1, further comprises changing the image based on the change of the scene in the video being displayed.

5. The method of claim 1, wherein the at least one selectable item further comprises allowing a user to move a pointing device to select the image of the at least one selectable item.

6. The method of claim 1, wherein the image is a representative image of the scene in the video.

7. The method of claim 1, wherein the selectable item includes an individual or physical object.

8. The method of claim 1, further comprising determining the portion of the video being displayed comprises:
receiving an audio signal from the video being displayed and based on the audio signal determining the temporal location of the video.

9. The method of claim 8, wherein determine the temporal location comprises comparing the received audio signal with database of audio signals.

10. The method of claim 1, further comprising determining the portion of the video being displayed comprises:
receiving an indication regarding the temporal location of the video;
wherein the indication includes a time stamp from the user.

11. The method of claim 1, further comprising determining the portion of the video being displayed comprises:
receiving the temporal location from a device that is configured to provide a display of the video.

12. An apparatus for visual selection of items in a video comprising:
a computer device configured to determine the segment of the video being displayed on a first user device;
a different computer device configured to send data to a second user device, the data comprising an image that includes at least a portion of the video being displayed;
the image having at least one selectable item, wherein in the case where a user selects the at least one item, a menu displays options that provide the user information regarding the at least one item.

13. The apparatus of claim 12, wherein the second user device displays a new image in the case where the video being played progresses to a new scene.

14. The apparatus of claim 12, wherein the menu includes selectable links to websites that provide more information regarding the at least one item.

15. The method of claim 14, wherein the time synchronizing includes providing a new image based on the change of the scene in the video being displayed.

16. The method of claim 12, wherein the at least one selectable item further comprises allowing a user to move a pointing device to select the image of the at least one selectable item.

17. The method of claim 12, wherein the image is a representative image of the scene in the video.

18. The method of claim 12, wherein the selectable item includes an individual or a physical object.

19. A method stored on a non-transitory machine-readable media for visually selecting items in a video, the machine-readable medium comprising program code stored therein executable by one or more processors, comprising:
providing using an image generation system an image that displays a portion of a scene in a video that is being displayed on a first device, the image having at least one selectable item;
in the case where the item is selected, displaying a menu that allows a user to receive more information about the item; and
the image configured to be displayed on a second device such that the image is time synchronized with the video being displayed.

20. The method of claim 19, wherein the at least one selectable item further comprises allowing a user to move a pointing device to select the image of the at least one selectable item.

21. The method of claim 19, further comprising determining the portion of the video being displayed comprises:
receiving an audio signal from the video being displayed and based on the audio signal determining the temporal location of the video; and
comparing the received audio signal with database of audio signals.
